(19) United States
(12) Patent Application Publication
(10) Pub. No.: US 2013/0098764 A1
(43) Pub. Date: Apr. 25, 2013

(54) METHOD FOR PRODUCING REACTION INSTRUMENT FOR ELECTROPHORESIS, APPARATUS FOR PRODUCING REACTION INSTRUMENT FOR ELECTROPHORESIS, BASE FOR GEL IMMOBILIZATION, REACTION INSTRUMENT FOR ELECTROPHORESIS AND KIT FOR ELECTROPHORESIS

(71) Applicants: Hiroshi Ohki, Osaka-shi (JP); Yutaka Unuma, Osaka-shi (JP); Yuji Maruo, Osaka-shi (JP); Tsuyoshi Tanaka, Osaka-shi (JP); Hiroshi Yamaki, Osaka-shi (JP)

(72) Inventors: Hiroshi Ohki, Osaka-shi (JP); Yutaka Unuma, Osaka-shi (JP); Yuji Maruo, Osaka-shi (JP); Tsuyoshi Tanaka, Osaka-shi (JP); Hiroshi Yamaki, Osaka-shi (JP)

(73) Assignee: SHARP KABUSHIKI KAISHA, Osaka (JP)

(21) Appl. No.: 13/704,886

(22) PCT Filed: Jan. 12, 2011
(86) PCT No.: PCT/JP2011/050367

§ 371 Date: Dec. 17, 2012

(30) Foreign Application Priority Data
Jun. 18, 2010 (JP) 2010-139354
Jun. 18, 2010 (JP) 2010-139355

(51) Int. Cl. G01N 27/447

(52) U.S. Cl. CPC G01N 27/44795
USPC 204/466; 204/606; 204/610; 427/58; 427/539; 118/313

(57) ABSTRACT

A production method of the present invention is a method of producing a reaction instrument for electrophoresis (10), which is constituted by (i) a substrate (1) and (ii) an electrophoresis gel (3) which is immobilized on the substrate (1), including the steps of: (i) discharging a liquid to a surface of the substrate (1) on which surface the gel is to be immobilized, thereby forming a liquid pool (5); and thereafter (ii) discharging a gel solution to the liquid pool (5). This provides a method of producing a reaction instrument for electrophoresis, which method makes it possible to form a gel with high reliability in high yield.

### TECHNICAL FIELD

The present invention relates to a method of producing a reaction instrument for electrophoresis, an apparatus for producing a reaction instrument for electrophoresis, a base for gel immobilization, a reaction instrument for electrophoresis, and a kit for electrophoresis.

### BACKGROUND ART

Electrophoresis is a phenomenon in which charged particles or charged molecules move through electric fields. In particular, in the fields of molecular biology and biochemistry, electrophoresis is an important technique to separate DNA or proteins.

In recent years, proteosome analysis has been attracting attention in post-genome. The proteosome analysis means a large-scale study on the structures and functions of proteins. For analysis of proteosome, usually, a protein sample is first separated into individual proteins. For example, two-dimensional electrophoresis is widely used to separate the protein sample.

Two-dimensional electrophoresis is a technique to separate a protein two-dimensionally by two-stage electrophoresis. For example, a protein is separated by isoelectric focusing (IEF) in the first dimension, and molecular masses are separated by sodium dodecyl sulfate-polyacrylamide gel electrophoresis (SDS-PAGE) in the second dimension. Such two-dimensional electrophoresis is very high in resolving power, and is capable of separating some several thousands or more of proteins into spots.

The IEF in the first dimension is carried out by for example an immobilized pH gradient (IPG) method, which is excellent in reproducibility and resolution. The immobilized pH gradient method uses an immobilized pH gradient gel (IPG gel).

Furthermore, in SDS-PAGE in the second dimension, for example an agarose gel or a polyacrylamide gel is used as an SDS-PAGE gel. In particular, in most cases, the polyacrylamide gel used in SDS-PAGE is a homogeneous gel in which an acrylamide solution is homogeneous. However, in a case where a wide range of molecular masses is to be analyzed, a gradient gel is used in which the concentration of an acrylamide solution gradually changes from high concentration to low concentration.

These IPG gel and SDS-PAGE gel are formed by for example (i) coating a plastic or a glass with a gel or (ii) pouring a gel solution into a mold (e.g., a mold such as a glass substrates facing each other via spacers) to cast the gel. The IPG gel and the SDS-PAGE gel are used in electrophoresis in the first dimension and electrophoresis in the second dimension, respectively.

In recent years, an electrophoresis method has been used very often for analyses of plant and animal genomes, and thus there has been a large demand for a technique of producing a homogeneous gel plate with high efficiency. In response to such a demand, there have been developed (i) a gel plate for electrophoresis which employs an ink-jet system and (ii) a method of producing the gel plate (Patent Literature 1).

### CITATION LIST

### Patent Literature

Patent Literature 1
Japanese Patent Application Publication, Tokukai, No. 2004-77393 A (Publication Date: Mar. 11, 2004)

### SUMMARY OF INVENTION

### Technical Problem

However, according to the gel plate of Patent Literature 1, wettability is poor between a plate and a gel solution. Accordingly, fine droplets of the gel solution discharged from an ink-jet head to the plate are not mixed sufficiently with each other. This causes a reduction in yield.

In electrophoresis, a gel having a concentration gradient is used sometimes. If wettability is poor between a plate and a gel solution, it is difficult to produce a gel that has a desired concentration gradient.

The present invention has been made in view of the problems, and an object of the present invention is to provide a method of producing a reaction instrument for electrophoreses, which method is capable of forming a gel with high reliability in high yield.

### Solution to Problem

In order to attain the above object, a method of producing a reaction instrument for electrophoresis in accordance with the present invention, which reaction instrument is constituted by a base and an electrophoresis gel immobilized on the base, includes the steps of: (1) discharging a liquid to a surface of the base on which surface the electrophoresis gel is to be immobilized, thereby forming a liquid pool on the surface; and thereafter (2) discharging a gel solution to the liquid pool.

In order to attain the above object, a method of producing a reaction instrument for electrophoresis in accordance with the present invention, which reaction instrument is constituted by a base and an electrophoresis gel immobilized on the base, includes: first discharging means for discharging a liquid to a surface of the base on which surface the electrophoresis gel is to be immobilized, thereby forming a liquid pool on the surface; and second discharging means for discharging a gel solution to the liquid pool thus formed.

According to the configuration, according to the present invention, first, the liquid is discharged to the base so as to form the liquid pool, and the gel solution is discharged to the liquid pool thus formed. This makes it possible to improve the quality of a gel to be formed.

Specifically, when the gel solution is directly discharged on the surface of the base, if wettability between the base and the gel solution is not good, droplets of the discharged gel solution cannot be mixed together sufficiently. This as a result causes the gel to be formed to be insufficient in quality. In this case, the gel solution cannot sufficiently spread on the desired region, i.e. on the region on which the gel is to be formed. This results in a reduction in yield (i.e., percentage of good products) of reaction instruments for electrophoresis to be produced.

According to the present invention, a liquid pool is formed on the base by discharging a liquid in advance, thereby improving wettability between the base and the gel solution that is subsequently discharged. This allows for the gel solution to spread across the desired region. As a result, it is possible to form the gel on the base with good positional reproducibility, thereby improving the yield thereof.

Moreover, since the droplets of the discharged gel solution can be sufficiently mixed together by the improved wettability, the gel strengthens in adhesion. This makes it possible to produce a highly-reliable reaction instrument for electrophoresis.

In order to attain the above object, a base for gel immobilization in accordance with the present invention, on which base an electrophoresis gel is to be immobilized, includes, in at least part of a surface on which the electrophoresis gel is to be immobilized, a gel adhesion region which has been subjected to a treatment to cause the electrophoresis gel to adhere to the gel adhesion region.

In order to attain the above object, a reaction instrument for electrophoresis in accordance with the present invention includes: a base for gel immobilization in accordance with the present invention; and an electrophoresis gel immobilized on the base.

According to the configuration, the base for gel immobilization in accordance with the present invention has been subjected to a treatment to cause a gel to adhere. The treatment can be carried out with respect to a desired region of a supporting base, in the form of a desired shape. The gel solution discharged to the supporting base is immobilized first in the gel adhesion region which has been subjected to the treatment.

Since it is possible to align the gel to the supporting base with high accuracy like above, it is possible to form a gel with high reliability in high yield.

In particular, according to a method of producing a reaction instrument for electrophoresis in accordance with the present invention (described later), it is possible to form a liquid pool in a gel adhesion region of a base for gel immobilization, by discharging a liquid to the gel adhesion region. By further discharging a gel solution to the liquid pool, it is possible to cause droplets of the gel solution to be sufficiently mixed together.

### Advantageous Effects of Invention

A method of producing a reaction instrument for electrophoresis in accordance with the present invention is a method of producing a reaction instrument for electrophoresis, which reaction instrument is constituted by a base and an electrophoresis gel immobilized on the base, including the steps of: (1) discharging a liquid to a surface of the base on which surface the electrophoresis gel is to be immobilized, thereby forming a liquid pool on the surface; and thereafter (2) discharging a gel solution to the liquid pool. Therefore, it is possible to form a gel with high reliability in high yield.

A base for gel immobilization in accordance with the present invention is a base for gel immobilization, on which base an electrophoresis gel is to be immobilized, including, in at least part of a surface on which the electrophoresis gel is to be immobilized, a gel adhesion region which has been subjected to a treatment to cause the electrophoresis gel to adhere to the gel adhesion region. Therefore, it is possible to form a gel with high reliability in high yield.

### BRIEF DESCRIPTION OF DRAWINGS

FIG. 1 is a cross sectional view illustrating procedures for producing a reaction instrument for electrophoresis according to one embodiment of the present invention.

FIG. 2 (a) of FIG. 2 is a perspective view illustrating a configuration of a reaction instrument for electrophoresis produced by a production method according to an embodiment of the present invention, and (b) of FIG. 2 is a cross sectional view illustrating a configuration of a reaction instrument for electrophoresis produced by a production method according to an embodiment of the present invention.

FIG. 3 is a perspective view illustrating another configuration of a gel adhesion region of the reaction instrument for electrophoresis illustrated in FIG. 2.

FIG. 4 is a perspective view illustrating another configuration of a gel adhesion region of the reaction instrument for electrophoresis illustrated in FIG. 2.

FIG. 5 is a perspective view illustrating another configuration of a gel adhesion region of the reaction instrument for electrophoresis illustrated in FIG. 2.

FIG. 6 is a perspective view illustrating another configuration of a gel adhesion region of the reaction instrument for electrophoresis illustrated in FIG. 2.

FIG. 7 is a perspective view illustrating procedures of producing a reaction instrument for electrophoresis according to an embodiment of the present invention.

FIG. 8 is a perspective view illustrating procedures of producing a reaction instrument for electrophoresis according to an embodiment of the present invention.

FIG. 9 is a block diagram schematically illustrating a configuration of an apparatus for producing a reaction instrument for electrophoresis according to an embodiment of the present invention.

### DESCRIPTION OF EMBODIMENTS

Described below is an embodiment of the present invention. It should be noted that the following description serves only to describe the present invention, and does not limit the scope of the present invention.

(Method of Producing Reaction Instrument for Electrophoresis)

A method according to the present invention for producing a reaction instrument for electrophoresis is a method for producing a reaction instrument for electrophoresis, which reaction instrument is constituted by a base and an electrophoresis gel immobilized on the base, including at least: a first discharging step for discharging a liquid to a surface of the base on which surface the electrophoresis gel is to be immobilized, thereby forming a liquid pool; and a second discharging step for discharging, after the first discharging step, a gel solution to the liquid pool.

Electrophoresis is a method of separating a biopolymer such as a protein, DNA or RNA by utilizing differences between moving velocities in a predetermined electric field, which differences are caused by a difference in size and electric charge. The electrophoresis includes a method in which the biopolymer is moved inside a supporting body such as a gel or the like. Examples thereof encompass polyacrylamide gel electrophoresis and agarose gel electrophoresis.

The reaction instrument for electrophoresis produced in the present invention is a base on which a gel is immobilized, which gel serves as a supporting body for separating components in a sample by electrophoresis. For example, the reaction instrument can suitably be used for two-dimensional electrophoresis in which a protein separated by isoelectric focusing (IEF) is further separated by sodium dodecyl sulfate-polyacrylamide gel electrophoresis (SDS-PAGE).

The base has a gel formed and immobilized on at least a part of its surface, and may be for example a flat plate or a chip formed into a preferred shape. The base may be made of, for example, glass, resin, or ceramics.

Among these materials, the glass may be, for example, quartz glass or non-alkali glass, the resin may be, for example, polyethylene terephthalate (PET) or polymethyl methacrylate (PMMA), and the ceramics may be, for example, alumina or low temperature co-fired ceramic.

Moreover, although not limited in particular, it is preferable that an optional region on an upper surface of the base has a shape of a depression or a protrusion, or that a plurality of depressions and/or protrusions are formed within that region. This allows for controlling the region on which the liquid pool of the discharged liquid is formed when the liquid is discharged in the first discharging step described later. Moreover, this allows also for retaining a liquid phase that is obtained as a result of collecting the discharged droplets of the gel solution when the gel solution is discharged in the second discharging step described later.

The first discharging step is a step of discharging a liquid onto a surface of the base on which surface the gel is to be immobilized, to form a liquid pool on the surface of the base. The liquid pool (droplet-trapped region) in the present embodiment indicates a state in which the discharged liquid remains on the base. The region in which the liquid pool is formed can serve as, for example, a preferred region on which the gel is to be formed.

The liquid is not limited in particular as long as it does not affect the formation of the gel, however it is preferably, for example, an aqueous solvent, and is more preferably a solution containing a reagent that accelerates the gelation of the second solution.

In the first discharging step, the liquid is discharged by use of, for example, a pipetter, a dispenser, or an ink-jet head. Moreover, the liquid is discharged by an amount that can be set as appropriate in response to a thickness that the gel is to be formed. For example, in a case in which a thick gel is desirably formed, the liquid is preferably discharged so that a deep liquid pool is formed, and in a case in which a thin gel is desirably formed, the liquid is preferably discharged so that a shallow liquid pool is formed. As one example, the liquid can be discharged so that a liquid pool having a depth of for example 0.2 mm to 0.4 mm is formed.

The second discharging step is a step of discharging the gel solution to the liquid pool formed in the first discharging step. The present invention allows for improving the quality of the gel by forming a liquid pool on where the gel solution is to be discharged.

Specifically, when the gel solution is directly discharged on the surface of the base, if wettability between the base and the gel solution is not good, droplets of the discharged gel solution cannot be mixed together sufficiently. This as a result causes the gel to be formed to be insufficient in quality. In this case, the gel solution cannot sufficiently spread on the desired region, i.e. on the region on which the gel is to be formed. This results in a reduction in yield (i.e., percentage of good products) of reaction instruments for electrophoresis to be produced.

In the present invention, a liquid pool is formed on the base by discharging a liquid in advance, thereby improving wettability between the base and the gel solution that is subsequently discharged. This allows for the gel solution to spread across the desired region. As a result, it is possible to form the gel on the base with good positional reproducibility, thereby improving the yield thereof.

Moreover, since the droplets of the discharged gel solution can be sufficiently mixed together by the improved wettability, the gel strengthens in adhesion. This makes it possible to produce a highly-reliable reaction instrument for electrophoresis.

Examples of the gel solution encompass (i) an acrylamide-mixed solution in which acrylamide that forms the main framework of the gel is mixed with N,N′-methylenebis acrylamide that crosslinks the main framework of the gel, (ii) an immobiline-mixed solution, (iii) an agarose-mixed solution, and like solution.

The gel solution is discharged in the second discharging step with use of, for example, a pipetter, dispenser, or ink-jet head. In particular, is preferable to discharge the gel solution with use of the ink-jet head.

The ink-jet head allows for discharging the solution in fine droplets. Hence, by discharging the gel solution in fine droplets to the liquid pool formed for improving wettability between the base and the gel solution, it is possible to easily produce a gel of a preferable shape.

Discharging methods using the ink-jet head are classified mainly into a continuous discharging type (continuous ink-jet) and an on-demand type (drop-on-demand ink-jet). Furthermore, the continuous ink-jet includes, for example, a charge-controlled system that controls charged fine droplets by an electric field, and the drop-on-demand ink-jet includes, for example, a thermal (bubble) system, an electrostatic actuator system, and a piezo system.

Moreover, in the second discharging step, it is preferable that the gel solution is discharged so that a formed gel has a gel concentration gradient or a pH gradient, such as a gradient gel or an immobilized pH gradient (IPG).

The IPG gel is a gel used in IEF, and has a gradient with respect to a pH level. Moreover, the gradient gel is a gel used in SDS-PAGE, and has a gradient with respect to an acrylamide concentration.

When preparing such an IPG gel or a gradient gel, it is necessary to sufficiently manage the pH level or gel concentration. When the gel solution is discharged to the base, the gel solution is likely to be discharged in fine droplets. Accordingly, by improving the wettability with use of the liquid pool formed on the surface of the base, the fine droplets of the gel solution are suitably mixed together.

The gel formed as a result of carrying out these steps serves as a supporting body for separating biopolymers such as protein or the like by electrophoresis. For example, the gel contains polyacrylamide gel or agarose gel. According to the present invention, since the gel solution is discharged to the liquid pool formed in advance, it is possible to form the gel on a desired position with good reproducibility.

Although the thickness of the gel is not limited in particular, it is preferable that the thickness is around several hundred millimeters to several millimeters. By having the gel formed in this thickness range, it is possible to use the gel optimally in electrophoresis tests.

Moreover, in the present invention, it is preferable to include, after the second discharging step, a third discharging step of discharging a polymerization initiator to the liquid pool. Namely, it is preferable to discharge a reagent for forming the gel in multiple stages.

The polymerization initiator is a solution for initiating gelation of the gel solution, and for example can be ammonium peroxosulfate (APS) or the like. For instance, if the polymerization initiator is discharged before or simultaneously with the gel solution, the polymerization of the gel may be initiated while the gel solution is being discharged, thereby causing unnecessary gelation inside a gel production tool or a gel production apparatus (apparatus for producing a reaction instrument).

Moreover, a general amount of the gel solution discharged by an ink-jet head in one scan is 1 ul. To increase the thickness of the gel, the number of scan operations is increased. Hence, the gel solution discharged earlier may become a gel before all the gel solutions have been discharged. This makes it difficult to form a gel of good quality.

Accordingly, by discharging the polymerization initiator after the step of discharging the gel solution, it is possible to control its gelation time. Namely, in the foregoing method, a timing of the gelation is controlled on the base, different from the conventional technique in which a gel solution that contains gel particles beforehand is discharged on the base and the gel is formed by drying or carrying out a similar process to that gel solution thereafter. As a result, it is possible to prevent an occurrence of a malfunction in the apparatus such as a clogging of pipes caused by progression of needless gelation reactions, thereby allowing for producing a gel having a thickness of, for example, 100 μm or more.

Furthermore, for example, a treatment of chemically modifying the properties of the surface of the base can be carried out before the first discharging step. More specifically, the region on which the liquid pool is to be formed may be treated so as to be hydrophilic, and the other regions may be treated so as to be hydrophobic.

That is to say, a hydrophilic region has good wettability with liquid, and a hydrophobic region has poor wettability with liquid. Hence, for example when liquid is discharged on the base, in the region having the good wettability, the liquid spreads and liquid pools are formed thereon, whereas in the region having the poor wettability, it is difficult for the liquid pool formed thereon to spread any more. Hence, it is possible to control a range on which the liquid pool is to be formed by providing on the base a hydrophilic region and a hydrophobic region.

Different treatments can be performed as the modification treatment of the surface of the base, depending on whether the surface on which the gel is to be immobilized on the base (such a surface is also referred to as gel formation surface) is made of hydrophilic material or is made of hydrophobic material.

For example, in a case in which the gel formation surface is made of hydrophobic material, it is possible to form a hydrophilic region on the base by carrying out a hydrophilizing treatment such as nitration by use of sulfuric acid or sulfonation by use of nitric acid, or by introducing or the like an oxygen-containing functional group by an oxygen plasma treatment (the step of carrying out a hydrophilizing treatment). In particular, it is preferable to perform the oxygen plasma treatment (oxygen plasma treatment step).

The oxygen plasma treatment is a treatment by which to modify a surface of a substance, and is a technique to improve hydrophilic properties by introducing an oxygen-containing substituent on the surface by plasma for example. Namely, the surface of the base on which the oxygen plasma treatment is carried out is improved in its wettability.

As described above, the wettability of the region on which the liquid pool is to be formed is improved by the oxygen plasma treatment. This hence allows for positional control so that the liquid discharged in the first discharging step forms a liquid pool on a desired region.

Moreover, for example, in a case in which the gel formation surface of the base is made of hydrophilic material, an appropriate hydrophobizing treatment is performed in accordance with the material of the base (the step of carrying out a hydrophobizing treatment).

For example, in a case in which the base is made of glass, a part to serve as the hydrophilic region is masked with a Kapton tape or the like, and the remaining regions are made hydrophobic by a treatment with use of a photolytic silane coupling agent. Thereafter, the part to serve as the hydrophilic region is irradiated with ultraviolet rays, so that that part becomes hydrophilic. This as a result forms a hydrophilic region and a hydrophobic region on the base.

Moreover, in a case in which the base is made of silicone, the region to serve as the hydrophilic region is masked with a natural oxide film, and the remaining regions are made hydrophobic by wet-etching the remaining regions with dilute hydrofluoric acid. Alternatively, the base may be washed with dilute hydrofluoric acid first, and then the regions other than the region to serve as the hydrophilic region are masked, which base is subjected to an oxidation treatment thereafter. Subsequently, any region is made hydrophilic by irradiation with ultraviolet ray or the like. As a result, a hydrophilic region and a hydrophobic region are formed on the base.

By forming a hydrophilic region and a hydrophobic region on the base by performing chemical surface modification treatments as described above, it is possible to provide a pattern to the gel with high positional reproducibility, by use of wettability according to hydrophilic and hydrophobic properties. Moreover, instead of the chemical surface treatment, the base may be physically provided with a plurality of depressions and/or protrusions to enlarge its surface area and improve wettability. The depressions and/or protrusions to be formed are preferably fine, as described later.

Moreover, as long as a region on which a depression or a protrusion is formed is present on the base, the range that the liquid pool is formed is defined by surface tension. Hence, it is possible to control the region on which the gel is to be formed.

Note that in the present specification, any region that has been subjected to a treatment so that the gel is to be formed (adhere) on that region on the base, such as (i) the region on which a surface modification treatment is performed, (ii) the region on which a depression or a protrusion is formed, or (iii) the region on which a depression and a protrusion are formed, is called a “gel adhesion region”, and a base having the gel adhesion region is called a “base for gel immobilization (gel-immobilizing base)”.

(Method of Producing Gel Plate 10)

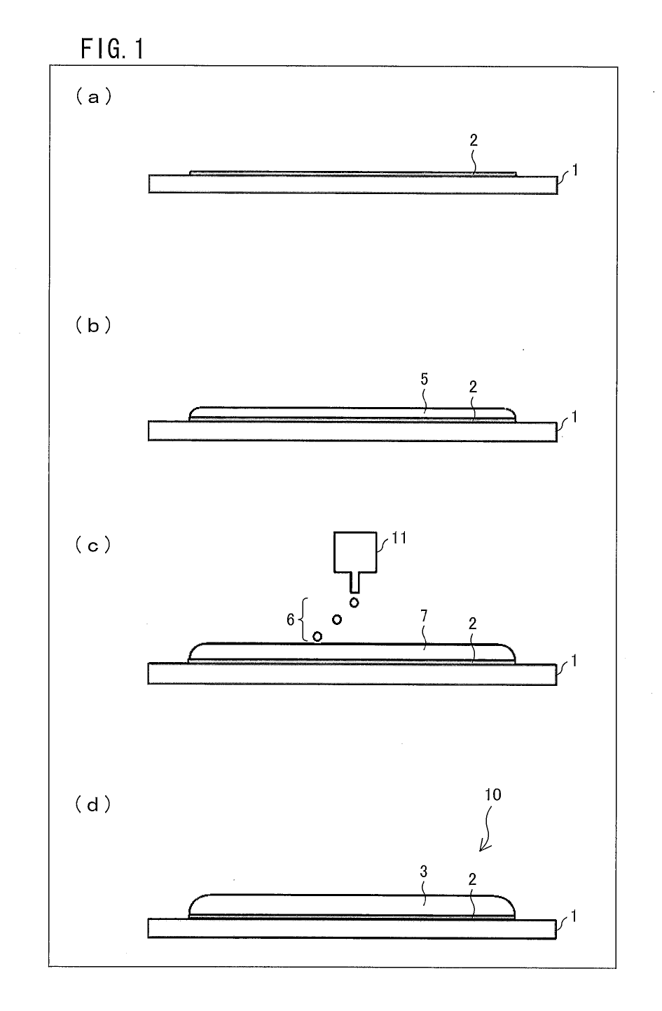

The following describes in details of a method of producing the reaction instrument for electrophoresis according to the present invention, with reference to drawings. First described are procedures of producing the reaction instrument for electrophoresis, in an embodiment of the present invention, with reference to FIG. 1. FIG. 1 is a cross sectional view illustrating procedures of producing the reaction instrument for electrophoresis, in accordance with an embodiment of the present invention.

Note that in the present embodiment, description is provided for a method of producing a gel plate 10 (reaction instrument for electrophoresis) on which a 4% polyacrylamide gel is formed, as one example. The 4% polyacrylamide gel is a typical gel used for electrophoresis.

Reagents used for forming the 4% polyacrylamide gel can be, for example, 30% acrylamide-mixed solution (acrylamide and N,N′-methylenebis acrylamide), 1M Tris-HCl, ammonium peroxosulfate (APS), N,N,N′,N′-tetramethylethylenediamine (TEMED), and pure water.

The acrylamide-mixed solution is a gel solution in which acrylamide (forming the main framework of the gel) is mixed with N,N′-methylenebis acrylamide (crosslinking the main framework of the gel), Tris-HCl is a buffer, APS is a polymerization initiator, and TEMED is a polymerization accelerator.

In the present embodiment, the reagents for forming the gel are discharged in three stages, however the number of times is not limited as long as the procedure includes a first discharging step in which a liquid is discharged and a second discharging step in which a gel solution is discharged.

First, an upper surface of a substrate 1 (base) is subjected to a surface modification treatment of for example oxygen plasma treatment or the like, to form a gel adhesion region 2. This gel adhesion region 2 is to serve as the gel-immobilizing base (see (a) of FIG. 1).

The gel adhesion region 2 is any region that has been subjected to a treatment so that the gel is to be formed (adhere) on that region on the base as described above, and may be, other than the region on which the surface modification treatment is performed, for example, a region on which a hollowed configuration in the form of a depression or a projected configuration in the form of a protrusion is formed, or a region on which fine depressions and/or protrusions are formed. Moreover, it is possible to employ these configurations in combination.

For example, polyethylene terephthalate (PET) sized 70 mm×13 mm may be used as the substrate 1. This substrate 1 is subjected to the surface modification treatment, to form the gel adhesion region 2.

In the present embodiment, the gel adhesion region 2 is formed before the first discharging step. The gel adhesion region 2 includes a hydrophilic region that is provided by masking parts other than the gel adhesion region 2 and performing the oxygen plasma treatment thereafter. It is more preferable to employ the surface modification treatment such as this oxygen plasma treatment and the like, for its easy patterning and its high productivity. At this time, the gel adhesion region 2 can have an area of for example 50 mm×2.4 mm.

Next, a first solution (liquid) is discharged to the gel adhesion region 2 of the substrate 1. At this time, the gel adhesion region 2 is made hydrophilic as a result of being subjected to the oxygen plasma treatment. Accordingly, the first solution remains on the gel adhesion region 2 with good positional reproducibility, and forms a liquid pool 5 (see (b) of FIG. 1).

Examples of the first solution encompass for example 1M Tris-HCl, TEMED, pure water, and a mixed solution of these. Amounts of these solutions are suitably set in accordance with a concentration of the polyacrylamide gel, and a mixed ratio in the mixed solution is not limited in particular. Moreover, means for discharging the first solution may be, for example, a pipetter, a dispenser or an ink-jet head.

The liquid discharged in the first discharging step is, as described above, preferably an aqueous solvent, and is further preferably a solution containing a reagent that accelerates the gelation of the second solution.

Namely, in a case in which the reaction system is inside an air phase, when the gel solution is discharged to the substrate 1, it is difficult to have fine droplets of the discharged gel solution mix sufficiently on the substrate 1. In comparison, by discharging liquid to the gel adhesion region 2 beforehand and forming the liquid pool 5, it is possible to cause the fine droplets to easily coalesce with each other, thereby allowing for sufficiently mixing the gel solution. In this case, use of the gel adhesion region 2 that has been treated by the surface modification treatment so as to be made hydrophilic allows for the gel solution to be more suitably mixed.

Moreover, in a case in which the liquid is a solution containing a reagent related to the gel formation, the reagent for forming the gel is discharged in multiple stages. Such a method of producing the gel allows for controlling the gelation time, and for example can prevent the malfunction of the apparatus such as the needless progression in the gelation reaction that causes pipes to clog.

After the first solution is discharged, the second solution is discharged to the gel adhesion region 2 on which the liquid pool 5 is formed. The second solution may be, for example, a gel solution such as 30% acrylamide-mixed solution.

The second solution may be discharged by means of, for example, a pipetter, a dispenser or an ink-jet head. It is preferable in particular to employ an ink-jet head that discharges fine droplets from a minute nozzle and applies the droplets to the substrate 1. As long as it is possible to discharge the second solution as fine droplets 6 by use of the ink-jet head 11 as illustrated in (c) of FIG. 1, it is possible to easily control the concentration of the gel and a formation region.

Moreover, for example, in a case of preparing IPG gel or gradient gel, a high-resolution gray scale (gradient) can be prepared by discharging, for example, the 30% acrylamide-mixed solution by use of the ink-jet head 11, with a gradient. This hence allows for providing a high-performance IPG gel or an SDS-PAGE gradient gel.

As in the present embodiment, by having the liquid pool 5 formed when the fine droplets 6 of the second solution are discharged from the ink-jet head 11, it is possible to largely accelerate the mixing of the fine droplets 6 discharged on the liquid pool 5. This prevents the deterioration in electrophoresis properties that occur when no liquid pool 5 is formed. Moreover, it is possible to form a highly precise gradient if necessary.

Next, a third solution is discharged to a mixed solution 7 of the first solution and the second solution (see (d) of FIG. 1). The third solution is, for example, an APS solution, and is sufficiently discharged by use of, for example, a pipetter, a dispenser, or an ink-jet head.

As a result, for example in a case in which a total amount of 80 μl of the first to third solution is discharged to a gel adhesion region 2 having an area of 50 mm×2.4 mm, a gel plate 10 is obtained on which a polyacrylamide gel 3 of 0.5 mm to 1.0 mm is formed.

Note that it is preferable that the preparation of the gel plate 10 is carried out in an inert gas (e.g. argon) atmosphere or a nitrogen atmosphere. That is to say, in a case in which the preparation of the gel plate 10 is carried out inside a reaction instrument (e.g., an instrument provided inside the apparatus for producing the gel), it is preferable that the inside of the reaction instrument is made in an inert gas (e.g. argon) or a nitrogen atmosphere while the gel plate 10 is being prepared, to exclude oxygen from the reaction instrument. This is because oxygen can serve as an inhibitor of the gelation reaction.

In typical conventional gelation reactions, the gel is cast into the gel production tool formed of a glass substrate or the like, so therefore it is difficult for the gel to be in contact with air. However, the gel plate 10 of the present embodiment directly draws the gel solution to the substrate 1. Hence, most parts of surfaces of the gel solution are exposed to air, and thus can easily be affected by oxygen. Therefore, it is preferable to have the inside of the reaction instrument be in an inert gas or nitrogen atmosphere.

However, in a case of producing the gel plate 10 in a simple manner, there are cases in which the gelation reaction is performed in air without using the reaction instrument or the like. In this case, it is preferable that the discharged amount of APS is made to be about 5% to 20% of an entire amount of the first to third solution discharged to the gel adhesion region 2 of the substrate 1, for example.

With an APS of 5% or more, the gel solution can sufficiently become a gel. Moreover, with the APS of not more than 20%, it is possible to prevent an uncontrollable state caused by a reduction in radicals required to initiate the gelation, which reduction is caused by the APSs affecting each other thereby causing the gelation speed to increase.

The APS, i.e., the third solution, is preferably discharged in the final stage, as described above. This allows for holding down the gelation of the gel solution inside the production tool or the apparatus for producing the gel, and for example prevents problems such as the clogging of pipes, etc. caused by the needless gelation inside the gel production tool or the gel production apparatus.

According to the production method of the gel plate 10 of the present embodiment, by discharging the solutions to the gel adhesion region 2 formed on any position on the substrate 1, it is possible to directly form the gel 3 of any size, composition, and concentration on the substrate 1, and can form the gel 3 with high positional reproducibility.

Hence, although conventionally a location that the gel is formed was restricted due to the formation of the gel plate by use of a casting tool such as a glass substrate or the like, according to the production method of the present embodiment, it is possible to form the gel on any position. For example, it is possible to form the gel on an edge surface of the substrate 1, or like position.

Next described is a configuration of a gel plate (including IFE chip, SDS-PAGE chip) produced by the production method according to the present embodiment. In the following description, an explanation is provided of a case in which the gel plate has a gel adhesion region. However, the present invention is not limited to the case of producing a gel plate that has the gel adhesion region, and can be applied to producing general gel plates on which a gel is immobilized on a substrate.

(Configuration of Gel Plate 10)

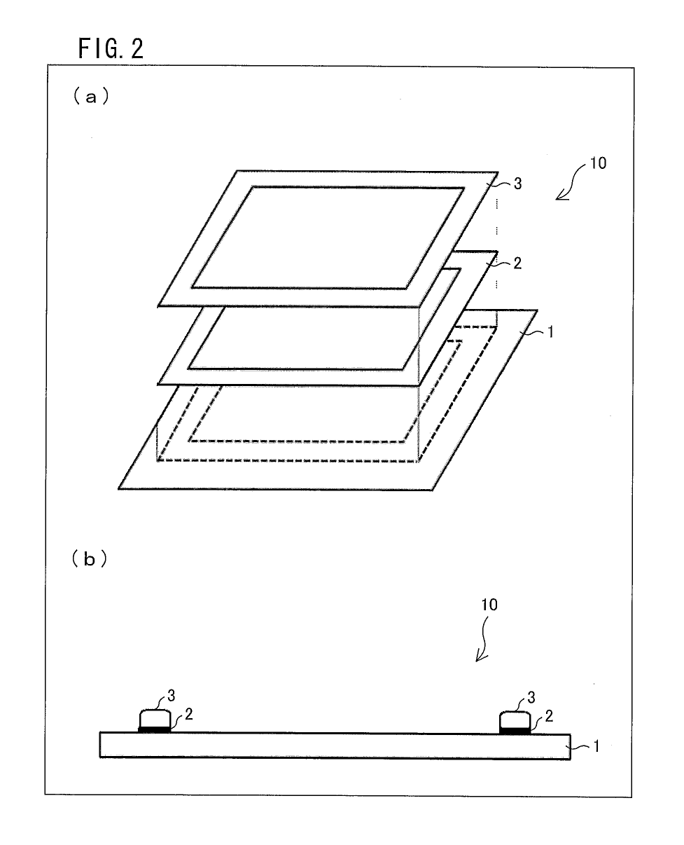

Described below is an example of a gel plate produced by a production method according to the present embodiment, with reference to FIGS. 2 to 6. Illustrated in (a) of FIG. 2 is a perspective view of a configuration of the gel plate 10, which gel plate 10 serves as one example of a gel plate produced by the production method according to the present embodiment. Illustrated in (b) of FIG. 2 is a cross sectional view illustrating a configuration of the gel plate 10.

The gel plate 10 illustrated in FIG. 2 is formed of a substrate 1 for immobilizing the electrophoresis gel, on which an electrophoresis gel 3 is immobilized. This substrate 1 has, on at least a part of its surface on which the gel 3 is to be immobilized, a gel adhesion region 2 which has been treated so that the gel 3 adheres thereto.

In FIG. 2, the gel adhesion region 2 is provided as a frame in the vicinity of an outer circumference of an upper surface of the substrate 1, and for example has a thickness of several nanometers (of a surface modification layer level) to several hundred micrometers (of a hollow structure level). By providing such a gel adhesion region 2 on the substrate 1, it is possible to form a liquid pool on a desired region. This hence allows for easily controlling the region on which the gel is formed.

However, the configuration of the gel adhesion region 2 is not limited to this, and for example may be a structure on which a structure in the form of a depression or a structure in the form of a protrusion is formed on any region on the upper surface of the substrate 1. Alternatively, fine depressions and/or protrusions may be formed on the upper surface of the substrate 1. Moreover, these structures may be used in combination.

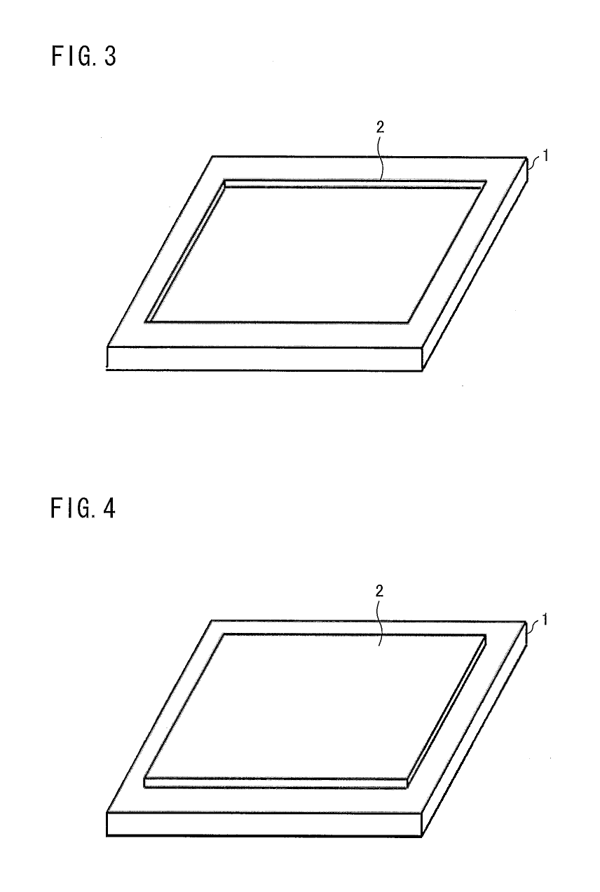

For example, the substrate 1 illustrated in FIG. 3 has a depressed structure (hollowed structure) of a desired pattern on the center of the upper surface. This hollowed structure can have a depth of for example several micrometers to several hundred micrometers; the depth is set as appropriate in response to the thickness of the substrate 1.

The method of preparing the hollowed structure can be selected in accordance with the material of the substrate 1. For example, if the substrate 1 is a glass substrate, the hollowed structure may be prepared by photolithography, i.e., by masking with a photoresist mask parts excluding a desired region for serving as the gel adhesion region 2, and etching the desired region. Moreover, in a case of a resin substrate, it is possible to prepare the hollowed structure by a cutting process or by injection molding.

Moreover, for example the substrate 1 illustrated in FIG. 4 has a protrusion structure (projected structure) of a desired pattern on a center of the upper surface, opposite to the substrate 1 illustrated in FIG. 3. This projected structure may have a depth of, for example, several micrometers to several hundred micrometers, however the depth may be set as appropriate in accordance with the thickness of the substrate 1.

The projected structure can be prepared by a similar method to the method of preparing the hollowed structure, as described above. For example, in the case in which the substrate 1 is a glass substrate, the region that is to serve as the gel adhesion region 2 is masked by a photoresist mask, and parts other than that desired region is etched to form the projected structure.

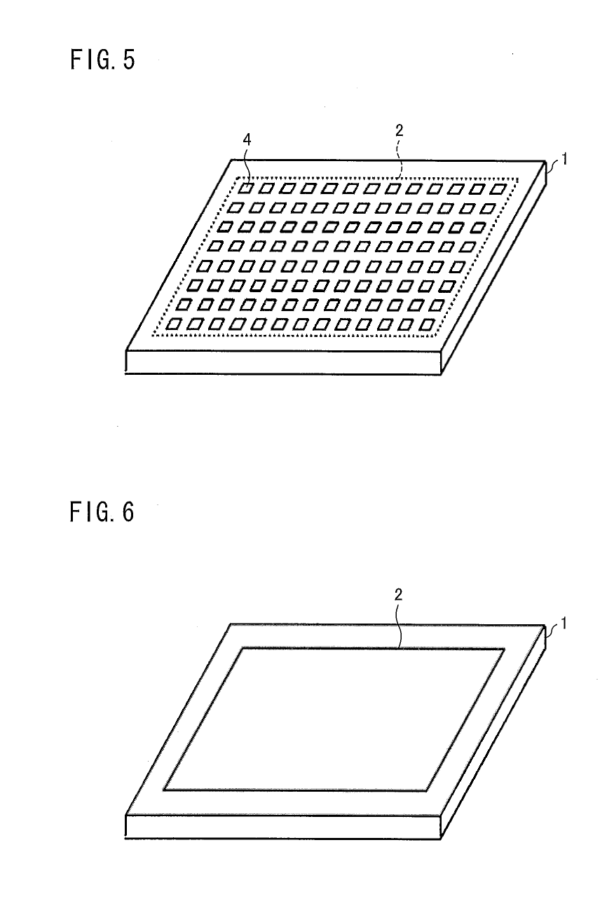

Furthermore, the gel adhesion region 2 may have a plurality of depressions and/or protrusions formed therein. It is preferable that the depressions and/or protrusions are fine. For example, a substrate 1 illustrated in FIG. 5 has fine depressions and/or protrusions 4 formed inside the gel adhesion region 2.

For example, at a time when the gel solution is discharged to the substrate 1 in fine droplets, the discharged droplets do not sufficiently mix with each other if the wettability between the gel solution and the substrate 1 is poor. This hence causes a gel formed to have poor electrophoresis properties. On the contrary, the fine depressions and/or protrusions 4 illustrated in FIG. 5 allows for controlling the region on which the gel is formed.

Namely, the liquid discharged in the first discharging step easily remains on the minute regions on which the fine depressions and/or protrusions 4 are formed. As a result, the wettability of those regions improves, thereby allowing for easier bonding between droplets of the gel solution discharged in the second discharging step. This hence allows for forming a gel 3 of a desired shape, efficiently.

The depressions and/or protrusions 4 can have a depth or a thickness of, for example, several nanometers to several ten nanometers, and can be suitably prepared by use of a generally known nanoimprint technique.

Moreover, the example illustrated in FIG. 5 has the depressions and/or protrusions 4 formed directly on the flat plane of the substrate 1. However, the configuration is not limited to this. For example, the depressions and/or protrusions 4 can be formed inside the gel adhesion region 2 of the configuration illustrated in FIGS. 2 to 4.

Moreover, as described above, the surface of the substrate 1 can be subjected to a treatment of chemically modifying properties of the surface of the base. For example, it is preferable to perform a treatment to the surface of the substrate 1 so that the region on which the liquid pool is to be formed is made hydrophilic, and other remaining regions are made hydrophobic.

For example, it is preferable that the gel adhesion region 2 of the substrate 1 illustrated in FIG. 6 includes a hydrophilic region having hydrophilic properties, and that the surface of the substrate 1 other than the hydrophilic region are hydrophobic. This improves the wettability of the gel adhesion region 2, thereby allowing for forming the gel 3 with good positional reproducibility.

The gel adhesion region 2 is made so as to be hydrophilic by performing different treatments depending on whether the surface of the substrate 1, at least in which the gel adhesion region 2 is formed, is made of hydrophilic material or of hydrophobic material. Note that the hydrophilizing treatment in accordance with the material is performed as described in the item “Method of producing reaction instrument for electrophoresis”, described above.

Moreover, it is preferable that the hydrophilic region be of a composition containing many oxygen-containing functional groups. In this case, for example, an organic resin having an oxygen-containing functional group may be used as the substrate 1, or a commercial organic resin can be subjected to a hydrophilizing treatment and be used as the substrate 1. The hydrophilic region is improved further in its wettability in a case in which the hydrophilic region has a composition that includes many oxygen-containing functional groups.

By forming the hydrophilic region and the hydrophobic region on the substrate 1 as described above by performing chemical surface modification treatments, it is possible to provide a pattern for the gel with good positional reproducibility, by utilization of the wettability in accordance with the hydrophilic and hydrophobic properties of the substrate 1.

It should be noted that the surface modification treatment of the substrate 1 can be performed to the substrates 1 of the configurations illustrated in FIGS. 2 to 5.

(Preparation of IEF Chip 20)

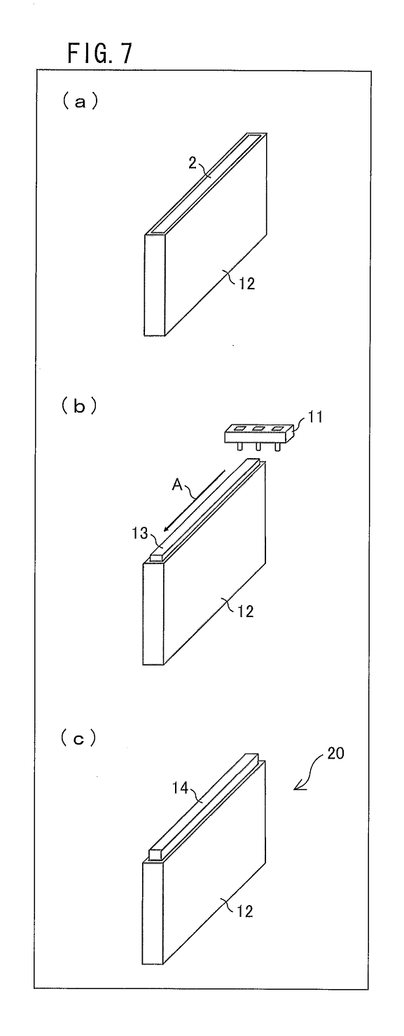

The following describes, as another example of a production method according to the present invention, a case of producing an IEF chip 20 as illustrated in FIG. 7. FIG. 7 is a cross sectional view showing procedures of producing the IEF chip 20. Note that the IPG gel formed on the IEF chip 20 illustrated in FIG. 7 can be suitably applied to a first medium (1D gel) disclosed in for example Japanese Patent Application Publication, Tokukai, No. 2007-64848 A (published Mar. 15, 2007), i.e. to an immobilized pH gradient gel.

Described below is the first dimension of the two-dimensional electrophoresis, i.e., the production method of an isoelectric focusing chip 20 (IEF chip) on which an immobilized pH gradient gel (IPG gel) is formed.

The generally known IEF chip used in IEF is obtained by casting IPG gel on a gel bonding film, and cutting this film into a desired shape.

For example, in a case in which the production method of the present embodiment is applied to such an IPG gel, it is possible to form the gel adhesion region 2 by (i) masking parts other than the part on which the gel adhesion region 2 is to be formed, on PET, i.e. the material of the gel bonding film, and (ii) performing an oxygen plasma treatment by glow discharge or arc discharge.

By use of the production method of the present embodiment in the preparation of the IEF chip on which IPG gel is immobilized, it is possible to sufficiently form the gel on a shape that was conventionally difficult to prepare.

As a reagent for forming the IPG gel, for example, an immobiline-mixed solution, an IEF reagent, TEMED, APS, and pure water may be used.

The immobiline-mixed solution is a solution in which two kinds of immobilines, for example of different pH levels, are mixed together. By mixing the immobilines that have various dissociation constants (pK) by use of an acrylamide derivative holding a positive charge or a negative charge, it is possible to obtain an immobiline-mixed solution having a desired pH level. Moreover, an IEF reagent (ampholine) is an amphoteric electrolyte mixture.

First, the gel adhesion region 2 is formed on an upper edge surface of a supporting base 12, as illustrated in (a) of FIG. 7. Used as the supporting base may be a plastic substrate such as polymethyl methacrylate (PMMA), or a glass substrate.

Moreover, it is preferable also in the present embodiment that the gel adhesion region 2 of the supporting base 12 is hydrophilic, and the regions other than the gel adhesion region 2 are hydrophobic. For example, in a case in which the supporting base 12 is made of PMMA, the gel adhesion region 2 having a hydrophilic region is formed by (i) masking regions other than the gel adhesion region 2 of the supporting base 12 and thereafter (ii) performing the oxygen plasma treatment or the sulfonation treatment.

Next, the first solution is discharged to the gel adhesion region 2 of the supporting base 12. The first solution contains an IEF reagent, TEMED, and pure water, for example. A mixing ratio of these is not limited in particular. This forms a liquid pool 13 on the gel adhesion region 2.

Means employed for discharging the first solution may be, for example, a pipetter, a dispenser, or an ink-jet head.

After the first solution is discharged, the second solution is discharged to the gel adhesion region 2 on which the liquid pool 13 is formed, to form a gradient. The second solution may be, for example, the immobiline-mixed solution.

Means for discharging the second solution may be, for example, a pipetter, a dispenser, or an ink-jet head. In particular, it is preferable that the ink-jet head is used. For example, as illustrated in (b) of FIG. 7, the ink-jet head 11 is made to scan the supporting base 12 in its longitudinal direction (direction of arrow shown by “A” in (b) of FIG. 7), so that a concentration gradient is generated for the two kinds of immobiline-mixed solutions, on the gel adhesion region 2 on which the liquid pool 13 is formed.

For example, an immobiline-mixed solution is adjusted so that one of the immobiline-mixed solutions is adjusted to a pH level of 3, and the other one of the immobiline-mixed solutions is adjusted to a pH level of 10. This immobiline-mixed solution is then discharged from the ink-jet head 11 in fine droplets. Note that a general method is used for the method of adjusting the immobiline-mixed solution, so hence explanation thereof is omitted.

It should be noted that an immobiline-containing gel solution 14, formed as a result of discharging the immobiline-mixed solution from the ink-jet head 11 to the liquid pool 13 ((c) of FIG. 7), does not undergo a gelation reaction and can remain in the form of a solution until the next step.

Subsequently, the third solution is discharged to the immobiline-containing gel solution 14. The third solution may be APS for example, and is sufficiently discharged with use of a pipetter, a dispenser, an ink-jet head or the like. However, it is preferable to use the ink-jet head.

For example, in a case in which APS is discharged with use of a pipetter or the like, the gelation of the region on which APS is not discharged is held down in response to the region on which APS is dropped. This causes deterioration in the evenness of the IPS gel. Meanwhile, the discharge of the APS with use of the ink-jet head allows for uniformly discharging the APS with respect to not just the flat surface of the gel adhesion region 2, but further with respect to a depth direction of the immobiline-containing gel solution 14.

This allows for obtaining, for example, an IEF chip 20 made of (i) a supporting base 12 having a pH level of 3 to 10 and whose IPG gel size is 50 mm (isoelectric point gradient direction)×2.4 mm×0.5 mm, and (ii) the IPG gel immobilized and formed on the supporting base 12 with good positional accuracy.

Note that in a case in which the IPG gel is prepared in an atmosphere other than in a nitrogen atmosphere or an inert gas (argon etc.) atmosphere, it is preferable that, for example, a volume ratio of APS (discharged volume of APS/entire discharged volume) is 5% to 20%. However, in a case in which the IPG gel is prepared in a nitrogen atmosphere or an inert gas (argon etc.) atmosphere, i.e., in a deoxidized atmosphere, the volume ratio of APS can be 1% or less.

(Preparation of SDS-PAGE Chip)

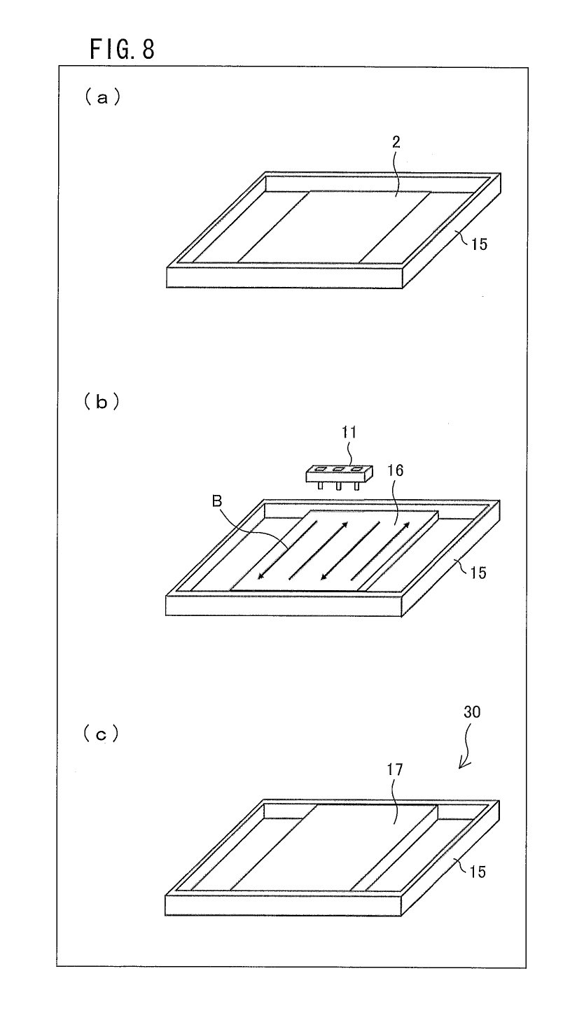

The following description will discuss, as another example of a production method in accordance with the present invention, a case where an SDS-PAGE chip 30 as shown in FIG. 8 is produced. FIG. 8 is a cross-sectional view illustrating procedures for producing the SDS-PAGE chip 30.

The following description will discuss a method of producing an SDS-PAGE chip 30 on which a gradient gel is formed, which is for use in the second dimension of two-dimensional electrophoresis (i.e., SDS-PAGE electrophoresis).

An SDS-PAGE chip 30 for use in known SDS-PAGE is constituted by (i) an instrument made of a plastic resin such as PMMA and (ii) a polyacrylamide gel cast on the instrument.

On the other hand, by using the method of producing the SDS-PAGE chip 30 of the present embodiment, it is not necessary to provide a casting structure, as is the case with the IEF chip 20. Therefore, a structure such as a flat plastic plate or a flat glass plate can be employed. Note that the gradient gel formed on the SDS-PAGE chip 30 is suitable for, for example, the second medium (2D gel) and the second separation part (sample instrument) and the gradient gel disclosed in Japanese Patent Application Publication, Tokukai, No. 2007-64848 A (Publication Date: Mar. 15, 2007).

Examples of a reagent for forming the gradient gel can include solutions similar to those used for the foregoing polyacrylamide gel.

First, as shown in (a) of FIG. 8, a gel adhesion region 2 is formed in a desired region of a supporting base 15, in which desired region the gradient gel is to be provided. The supporting base 15 used here is for example a plastic substrate such as PMMA or a glass substrate.

According also to the present embodiment, it is preferable that the gel adhesion region 2 of the supporting base 15 is hydrophilic and that a region other than the gel adhesion region 2 is hydrophobic. The gel adhesion region 2 which has a hydrophilic region can be formed by for example (i) masking the region of the supporting base 15, which region is other than the gel adhesion region 2 and thereafter (ii) carrying out an oxygen plasma treatment, a sulfonation treatment or a nitration treatment.

Next, a first solution is discharged to the gel adhesion region 2 of the supporting base 15. The first solution contains 1M tris-HCL buffer solution, TEMED, and pure water, for example. Mixing ratio of these is not particularly limited. In this way, a liquid pool 16 is formed in the gel adhesion region 2 (see (b) of FIG. 8).

The first solution is discharged with use of for example a pipetter, a dispenser or an ink-jet head.

After the first solution is discharged, a second solution is discharged to the gel adhesion region 2 where the liquid pool 16 is formed, thereby a gradient is formed. The second solution is for example an acrylamide-mixed solution (acrylamide and N,N′-methylenebis acrylamide). The concentration of the acrylamide-mixed solution can be for example 30% to 50% (acrylamide:N,N′-methylenebis acrylamide=37.5:1), which is relatively high.

The second solution can be discharged by for example a pipetter, a dispenser or an ink-jet head. It is particularly preferable to use an ink-jet head 11. For example, by carrying out scanning with use of the ink-jet head 11 along arrow indicated by “B” in (b) of FIG. 8, it is possible to suitably form a gradient.

Note that an acrylamide mixture-containing gel solution 17 ((c) of FIG. 8), which is formed by discharging the second solution through the ink-jet head 11 to the liquid pool 16, does not undergo a gelation reaction and can remain in the form of a solution until the next step.

Next, a third solution is discharged to the acrylamide mixture-containing gel solution 17. The third solution contains for example APS, and can be discharged with use of for example a pipetter, a dispenser or an ink-jet head. It is preferable to use an ink-jet head.

As is the case with the IEF chip 20, when APS is discharged, it is desirable that the APS is uniform not only with respect to a flat surface of the gel adhesion region 2 but also with respect to the thickness direction of the acrylamide mixture-containing gel solution 17. Therefore, it is preferable to use the ink-jet head. By discharging a desired amount of APS to the acrylamide mixture-containing gel solution 17 which has a gradient like above, it is possible to form a gradient gel on the gel adhesion region 2 formed in a desired region of the supporting base 15.

The SDS-PAGE chip 30 obtained in this way is constituted by for example the supporting base 15 and a gradient gel. The gradient gel (i) has a concentration of 4% on the low concentration side and 15% on the high concentration side, (ii) is 50 mm (in a direction of concentration gradient)×2.4 mm×0.5 mm in size, and (iii) is immobilized on the supporting base 15 with good positional accuracy.

In a case of producing a gradient gel in the atmosphere other than inert gas atmosphere such as nitrogen atmosphere or argon atmosphere, it is preferable that the volume ratio of APS (discharged volume of APS/entire discharged volume) is 5% or greater, for example. Note however that, in a case of producing an IPG gel in the inert gas atmosphere such as nitrogen atmosphere or argon atmosphere, i.e., in a deoxidized atmosphere, the volume ratio is not limited to this.

(Apparatus For Producing Reaction Instrument)

According to one embodiment, a method of producing a reaction instrument for electrophoresis in accordance with the present invention can be carried out by an apparatus for producing a reaction instrument for electrophoresis in accordance with the present invention. The apparatus can include (i) first discharging means for discharging a liquid to a surface of a base on which surface a gel is to be immobilized, thereby forming a liquid pool and (ii) second discharging means for discharging a gel solution to the liquid pool thus formed.

According to the apparatus of the present invention, it is possible to (i) form a liquid pool by the first discharging means discharging a liquid to the base and then (ii) discharge a gel solution by the second discharging means. Therefore, it is possible to suitably carry out the method of producing a reaction instrument for electrophoresis in accordance with the present invention.

Each of the first and second discharging means can be constituted by for example a pipetter, a dispenser or an ink-jet head. For example, the second discharging means is preferably configured to discharge the gel solution with use of an ink-jet head. Furthermore, the apparatus can further include third discharging means for discharging a polymerization initiator to the liquid pool, which is made of the gel solution discharged by the second discharging means.

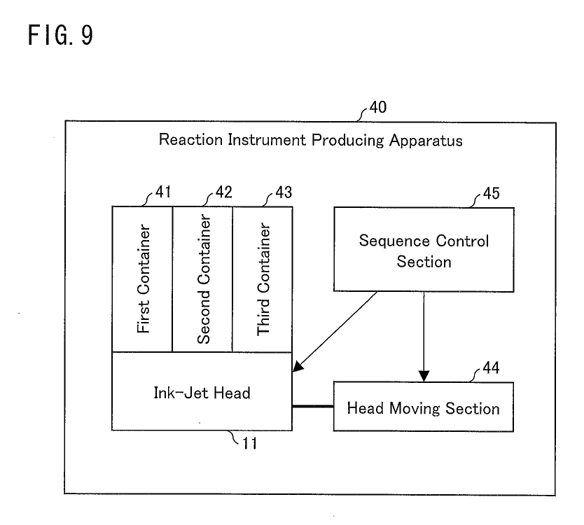

FIG. 9 is a block diagram schematically illustrating a configuration of a reaction instrument producing apparatus (an apparatus for producing a reaction instrument for electrophoresis) 40 in accordance with one embodiment of the present invention. As illustrated in FIG. 9, the reaction instrument producing apparatus 40 includes an ink-jet head 11, a first container 41, a second container 42, a third container 43, a head moving section 44, and a sequence control section 45. The reaction instrument producing apparatus 40 is capable of successfully producing a reaction instrument for electrophoresis, by carrying out a method of producing a reaction instrument for electrophoresis in accordance with the present invention.

The first container 41 retains therein the foregoing first solution, the second container 42 retains therein the foregoing second solution, and the third container 43 retains therein the foregoing third solution. The first container 41, the second container 42 and the third container 43 are connected to the ink-jet head 11 so that the solutions in the respective first to third containers are capable of being discharged through the ink-jet head 11. That is, the first container 41 and the ink-jet head 11 constitute the first discharging means, and the second container 42 and the ink-jet head 11 constitute the second discharging means. The third container 43 and the ink jet head 11 optionally constitute the third discharging means.

The head moving section 44 is constituted by for example an actuator, and causes the ink-jet head 11 to move. This makes it possible to easily form a gel in a desired position on a substrate. The sequence control section 45 is configured to carry out sequence control of the behaviors of the head moving section 44 and the ink-jet head 11 so that the foregoing steps of the method of producing a reaction instrument for electrophoresis are carried out.

(Material to be Separated)

A material to be separated through electrophoresis with use of a reaction instrument for electrophoresis produced by a production method of the present invention is not limited, provided that it is a material to be separated or analyzed through electrophoresis and transcription. For example, the material to be separated, which is suitably used, can be a preparation obtained from a biological material such as a biont, bodily fluid, cell strain, cultured tissue or tissue fragment. In particular, a polypeptide or a polynucleotide is more suitable.

(Kit for Electrophoresis)

The present invention further encompasses a kit for electrophoresis, which kit includes a base for gel immobilization in accordance with the present invention.

The kit can include, in addition to the base for gel immobilization in accordance with the present invention, a reagent related to gel formation, a buffer solution for electrophoresis, an instrument for electrophoresis and/or the like, for example.

The present invention is not limited to the descriptions of the respective embodiments, but may be altered within the scope of the claims. An embodiment derived from a proper combination of technical means disclosed in different embodiments is encompassed in the technical scope of the invention. In addition, all the citations stated in the description are incorporated herein by reference.

The method of producing a reaction instrument for electrophoresis in accordance with the present invention is preferably arranged such that the step (2) includes discharging the gel solution with use of an ink-jet head.

According to the arrangement, the gel solution is discharged with use of the ink-jet head. The ink-jet head allows for discharging the solution in fine droplets. Hence, by discharging the gel solution in fine droplets to the liquid pool formed for improving wettability between the base and the gel solution, it is possible to easily produce a gel of a preferable shape.

Furthermore, for example in a case of producing a gel that has a desired concentration distribution (such a gel is for example IPG gel or gradient gel), it is possible to produce a high-resolution gray scale (gradient) by discharging the gel solution with use of the ink-jet head. This makes it possible to provide a high-performance IPG gel or SDS-PAGE gradient gel.

It is preferable that the method of producing a reaction instrument for electrophoresis in accordance with the present invention further includes, after the step (2), the step (3) of discharging a polymerization initiator to the liquid pool.

According to the arrangement, the polymerization initiator for initiation of gel polymerization is discharged after the gel solution is discharged.

For instance, if the polymerization initiator is discharged before or simultaneously with the gel solution, the polymerization of the gel may be initiated while the gel solution is being discharged, thereby causing unnecessary gelation inside a gel production tool or a gel production apparatus.

Furthermore, for example in a case of discharging the gel solution with use of the ink-jet head, the amount of the gel solution to be discharged per scan is generally 1 μL. Therefore, the number of scan operations needs to be increased for an increase in the film thickness. Accordingly, a gel solution that has been discharged earlier may become a gel before the discharge of the entire gel solution is complete. This makes it difficult to form a gel of good quality.

In view of this, since the discharge of the polymerization initiator is carried out after the step of discharging the gel solution, it is possible to control the timing of polymerization to thereby prevent unnecessarily gelation in the processing system.

It is preferable that, in a case where at least part of the surface on which the electrophoresis gel is to be immobilized is made of a hydrophobic material, the method of producing a reaction instrument for electrophoresis in accordance with the present invention further includes, before the step (1), the step of carrying out a hydrophilizing treatment with respect to a region where the liquid pool is to be formed. Furthermore, the step of carrying out the hydrophilizing treatment preferably includes carrying out an oxygen plasma treatment.

According to the arrangement, it is possible to improve wettability of the gel adhesion region before the discharge of the liquid. This makes it possible for the liquid thus discharged to form a liquid pool in a desired region. Furthermore, by carrying out the oxygen plasma treatment with use of for example a plasma blocking mask, it is possible to form, in a desired position, a region that has a composition containing a large number of oxygen-containing functional groups. This significantly contributes to an improvement in position reproducibility of a gel.

It is preferable that, in a case where at least part of the surface on which the electrophoresis gel is to be immobilized is made of a hydrophilic material, the method of producing a reaction instrument for electrophoresis in accordance with the present invention further includes, before the step (1), the step of carrying out a hydrophobizing treatment with respect to a region other than a region where the liquid pool is to be formed. Furthermore, the step of carrying out the hydrophobizing treatment preferably includes carrying out a silane coupling treatment.

According to the arrangement, it is possible to improve wettability of the gel adhesion region before the discharge of the liquid. This makes it possible for the liquid thus discharged to form a liquid pool in a desired region.

The base for gel immobilization in accordance with the present invention is preferably configured such that the gel adhesion region has a shape of a depression or a protrusion.

According to the configuration, the gel adhesion region has a projection or a depression on a surface of the base for gel immobilization. By forming such a structure in advance, it is possible to control the position of a gel to be formed. This makes it possible to improve alignment of the gel to the supporting base.

The base for gel immobilization in accordance with the present invention is preferably configured such that the gel adhesion region has a plurality of depressions and/or protrusions.

Since a plurality of depressions and/or protrusions are formed in the gel adhesion region on the base for gel immobilization like above, it is possible to control wettability. In particular, by forming depressions and/or protrusions in minute areas, it is possible to form the gel in those areas with high efficiency.

The base for gel immobilization in accordance with the present invention is preferably configured such that: at least part of the gel adhesion region is hydrophilic; and at least part of a region of the surface, which region is other than the gel adhesion region, is hydrophobic.

For example, (i) a region of the surface of a hydrophobic material such as a plastic substrate, which region is to become a gel adhesion region, is caused to be hydrophilic by the hydrophilizing treatment such as the oxygen plasma treatment and/or (ii) a region of the surface of a hydrophilic material such as a glass substrate, which region is other than the gel adhesion region, is caused to be hydrophobic by the hydrophobizing treatment such as the silane coupling treatment.

Since the surface of the base for gel immobilization is patterned so as to have a hydrophilic region and a hydrophobic region like above, the wettability between the gel and a contact surface of the base for gel immobilization is good in the gel adhesion region. This makes it possible to form a gel of a desired shape.

The base for gel immobilization in accordance with the present invention is preferably configured such that said at least part of the gel adhesion region, which part is hydrophilic, has a composition containing an oxygen-containing functional group.

According to the configuration, it is possible to provide a base for gel immobilization in which the wettability between a gel and a contact surface of the base for gel immobilization is good.

The reaction instrument for electrophoresis in accordance with the present invention is preferably configured such that the electrophoresis gel has a gel concentration gradient or a pH gradient.

For example, in a case of producing (i) a gel having a pH gradient such as an immobilized pH gradient gel or (i) a gel having a gel concentration gradient such as a gradient gel, it is necessary to well control the composition and concentration etc. of the gel. According to the present invention, since the gel adhesion region has been subjected to a surface modification treatment etc., the wettability between the gel solution and the surface of the gel adhesion region of the substrate is good when the gel is produced. This makes it possible to easily control the position in which the gel is to be immobilized.

Therefore, it is possible to form, in any position, a gel of any size which has any composition and any concentration. Accordingly, it is possible to suitably form a gel having a pH gradient or a concentration gradient, such as an IPG gel or a gradient gel.

A method of producing a reaction instrument for electrophoresis in accordance with the present invention is a method of producing a reaction instrument for electrophoresis in accordance with the present invention, including the steps of: (1) discharging a liquid to the gel adhesion region; and thereafter (2) discharging a gel solution to the gel adhesion region.

For example, in a case where a gel solution is discharged to a base for gel immobilization, the wettability between the base and the gel solution may be poor and thus droplets of the gel solution thus discharged are not sufficiently mixed together. In view of this, by forming a liquid pool by discharging the liquid to the gel adhesion region in advance, fine droplets become likely to coalesce with each other. As such, it is possible to sufficiently mix the droplets of the gel solution.

Furthermore, for example in a case where the liquid is a gel solution containing a reagent related to gel formation, the gel solution is to be discharged in multiple stages. In such a case, it is possible to control time taken by gel formation. This makes it possible to prevent for example a malfunction in an apparatus, such as a clogging of a pipe due to unnecessary gelation reaction.

The method of producing a reaction instrument for electrophoresis in accordance with the present invention is preferably arranged such that the step (2) includes discharging the gel solution with use of an ink-jet head.

According to the arrangement, since the ink-jet head capable of discharging the gel solution in the form of fine droplets is used, it is easy to control the concentration of a gel and a region where the gel is to be formed.

Furthermore, for example in a case of producing an IPG gel or a gradient gel, it is possible to produce a high-resolution gray scale (gradient) by discharging the gel solution with use of the ink-jet head. This makes it possible to provide a high-performance IPG gel or SDS-PAGE gradient gel.

It is preferable that the method of producing a reaction instrument for electrophoresis in accordance with the present invention further includes, before the step (1), the step of forming the gel adhesion region by an oxygen plasma treatment.

According to the configuration, it is possible to improve wettability of the gel adhesion region before the liquid is discharged. This allows the liquid thus discharged to form a liquid pool in a desired region.

Furthermore, by carrying out the oxygen plasma treatment with use of for example a plasma blocking mask, it is possible to form, in a desired position, a region that has a composition containing a large number of oxygen-containing functional groups. This significantly contributes to an improvement in position reproducibility of a gel.

It is preferable that the method of producing a reaction instrument for electrophoresis in accordance with the present invention includes, after the step (2), the step (3) of discharging a polymerization initiator to the gel adhesion region.

According to the arrangement, the polymerization initiator for initiation of gel polymerization is discharged after the gel solution is discharged. This makes it possible to inhibit the gel solution from becoming a gel in a gel production tool or in a gel production apparatus, and thus prevent unnecessary gelation in the gel production tool or in the gel production apparatus (e.g., a clogging of a pipe).

In order to attain the foregoing object, a kit for electrophoresis in accordance with the present invention includes a base for gel immobilization in accordance with the present invention.

### INDUSTRIAL APPLICABILITY

The present invention is usable for polyacrylamide gel electrophoresis or agarose gel electrophoresis for separating a biopolymer such as a protein, DNA or RNA. In particular, the present invention is suitably applicable to two-dimensional electrophoresis including isoelectric focusing and SDS-PAGE electrophoresis.

### REFERENCE SIGNS LIST

1 Substrate (Base)
2 Gel adhesion region
3 Gel
10 Gel plate (Reaction instrument for electrophoresis)
20 IEF chip (Reaction instrument for electrophoresis)
30 SDS-PAGE chip (Reaction instrument for electrophoresis)
40 Reaction instrument producing apparatus (Apparatus for producing reaction instrument for electrophoresis)

1. A method of producing a reaction instrument for electrophoresis, which reaction instrument is constituted by a base and an electrophoresis gel immobilized on the base, comprising the steps of:
(1) discharging a liquid to a surface of the base on which surface the electrophoresis gel is to be immobilized, thereby forming a liquid pool on the surface; and thereafter
(2) discharging a gel solution to the liquid pool.

2. The method according to claim 1, wherein the step (2) includes discharging the gel solution with use of an ink-jet head.

3. The method according to claim 1, further comprising, after the step (2), the step (3) of discharging a polymerization initiator to the liquid pool.

4. The method according to claim 1, in a case where at least part of the surface on which the electrophoresis gel is to be immobilized is made of a hydrophobic material, further comprising, before the step (1), the step of carrying out a hydrophilizing treatment with respect to a region where the liquid pool is to be formed.

5. The method according to claim 4, wherein the step of carrying out the hydrophilizing treatment includes carrying out an oxygen plasma treatment.

6. The method according to claim 1, in a case where at least part of the surface on which the electrophoresis gel is to be immobilized is made of a hydrophilic material, further comprising, before the step (1), the step of carrying out a hydrophobizing treatment with respect to a region other than a region where the liquid pool is to be formed.

7. The method according to claim 6, wherein the step of carrying out the hydrophobizing treatment includes carrying out a silane coupling treatment.

8. An apparatus for producing a reaction instrument for electrophoresis, which reaction instrument is constituted by a base and an electrophoresis gel immobilized on the base, comprising:
first discharging means for discharging a liquid to a surface of the base on which surface the electrophoresis gel is to be immobilized, thereby forming a liquid pool on the surface; and
second discharging means for discharging a gel solution to the liquid pool formed on the surface.

9. A base for gel immobilization, on which base an electrophoresis gel is to be immobilized, comprising, in at least part of a surface on which the electrophoresis gel is to be immobilized, a gel adhesion region which has been subjected to a treatment to cause the electrophoresis gel to adhere to the gel adhesion region.

10. The base according to claim 9, wherein the gel adhesion region has a shape of a depression or a protrusion.

11. The base according to claim 9, wherein the gel adhesion region has a plurality of depressions and/or protrusions.

12. The base according to claim 9, wherein:
at least part of the gel adhesion region is hydrophilic; and
at least part of a region of the surface, which region is other than the gel adhesion region, is hydrophobic.

13. The base according to claim 12, wherein said at least part of the gel adhesion region, which part is hydrophilic, has a composition containing an oxygen-containing functional group.

14. A reaction instrument for electrophoresis, comprising:
a base for gel immobilization recited in claim 9; and
an electrophoresis gel immobilized on the base.

15. The reaction instrument according to claim 14, wherein the electrophoresis gel has a gel concentration gradient or a pH gradient.

16. A method of producing a reaction instrument for electrophoresis recited in claim 14, comprising the steps of:
(1) discharging a liquid to the gel adhesion region; and thereafter
(2) discharging a gel solution to the gel adhesion region.

17. The method according to claim 16, wherein the step (2) includes discharging the gel solution with use of an ink-jet head.

18. The method according to claim 16, further comprising, before the step (1), the step of forming the gel adhesion region by an oxygen plasma treatment.

19. The method according to claim 16, further comprising, after the step (2), the step (3) of discharging a polymerization initiator to the gel adhesion region.

20. A kit for electrophoresis, comprising a base for gel immobilization recited in claim 9.
